(19) United States
(12) Patent Application Publication
(10) Pub. No.: US 2024/0280486 A1
(43) Pub. Date: Aug. 22, 2024

(54) HOUSING FOR A SENSOR AND SENSOR

(71) Applicant: Eagle Actuator Components GmbH & Co. KG, Heppenheim (DE)

(72) Inventors: Siegfried DRIEMER, Fuerth (DE); Ralf Heinrich, Schwegenheim (DE); Felix Bittermann, Abtsteinach (DE)

(73) Assignee: Eagle Actuator Components GmbH & Co. KG, Heppenheim (DE)

(21) Appl. No.: 18/402,543

(22) Filed: Jan. 2, 2024

(30) Foreign Application Priority Data
Feb. 22, 2023 (DE) 102023104302.1

(51) Int. Cl. G01N 21/64

(52) U.S. Cl. CPC G01N 21/6428; G01N 2201/0228

(57) ABSTRACT

A housing for a sensor, comprising a housing upper part and a housing lower part which, in the assembled state, form a receiving space which is suitable to receive a circuit board, which, with regard to the object of specifying a housing for a sensor which receives a circuit board as far as possible in the correct position and protects the latter as reliably as possible against undesired movements relative to the housing is characterized in that deformable means are assigned to the housing upper part and/or the housing lower part which, in the assembled state of the housing parts, are bent into the receiving space.

### CROSS REFERENCE TO RELATED APPLICATIONS

This application claims the benefit of and priority to German patent application no. 10 2023 104 302.1, entitled “Gehäuse für einen Sensor und Sensor,” translated as “Housing for a sensor and sensor,” filed Feb. 22, 2023, the entirety of which is incorporated herein by reference.

### TECHNICAL FIELD

The invention relates to a housing for a sensor.

### BACKGROUND OF THE INVENTION

Sensors, including optical sensors, photodiodes, or similar sensors, may be used to detect light such as fluorescent light emitted by marker chemicals injected into human or animal tissue or organs and irradiated with an excitation light. However, the positional and stability requirements for such sensors are such that prior implementations of housings or structures to hold the sensors stationary (for example, during movement of the subject human or animal) have been inadequate. Additionally, manufacturing tolerances may result in gaps or deformation, resulting in light leakage and impaired or false sensor readings.

### SUMMARY OF THE INVENTION

In some aspects, implementations of the present disclosure solve the above-discussed and other problems by providing a housing for a sensor. The housing may comprise a housing upper part and a housing lower part which, in the assembled state, form a receiving space which is suitable to receive a circuit board. In some implementations, deformable means are assigned to the housing upper part and/or the housing lower part which, in the assembled state of the housing parts are bent into the receiving space.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout.

FIG. 1 is a schematic sectional view of a housing lower part, a circuit board and a housing upper part in an exploded illustration, according to some implementations;

FIG. 2 is another schematic sectional view of the housing lower part, circuit board, and housing upper part of FIG. 1 in a partially assembled state, according to some implementations;

FIG. 3 is another schematic sectional view of the housing lower part, circuit board, and housing upper part of FIG. 1 in an assembled state, according to some implementations; and

FIG. 4 is a schematic illustration of an arrangement which comprises the housing and a battery, wherein the housing and the battery are illustrated in a state separated from each other, according to some implementations.

The details of various embodiments of the methods and systems are set forth in the accompanying drawings and the description below.

### DETAILED DESCRIPTION OF THE PREFERRED EMBODIMENTS

From the prior art, it is known to investigate the function of human or animal organs by injecting a marker into them. The marker usually has a substance which can be excited to fluoresce by irradiation with excitation light. The decay of the fluorescence over time can be viewed as an indicator of how well an organ, in particular a kidney, breaks down the marker or the substance.

To detect the fluorescence, use is normally made of sensors which can be worn close to the body. Such a sensor frequently comprises a circuit board which has LEDs and at least one photodiode, and a housing which accommodates the circuit board and its electronics in a protective manner.

Particular requirements are placed on the housing. Firstly, the housing must conduct excitation light from the LEDs to the body of the human or animal and, secondly, reliably feed to the photodiode fluorescent light which is reflected back toward the sensor on the excitation light. As little extraneous light as possible, that is to say light superimposed on the fluorescent light, should fall on the photodiode.

This includes the fact that the circuit board must be supported as far as possible without play and in a defined position in the housing. In particular, the circuit board must not move in the housing when the human or the animal wearing the housing moves during a measurement, in particular long-term measurement.

It is already known from the prior art to produce housing parts from plastic by milling. However, this is associated with tolerances, which frequently do not make it easy to fix the circuit board firstly free of load and secondly firmly between two housing parts.

When joining two milled housing parts which are intended to fix the circuit board securely, the circuit board can be loaded with excessive pressure and therefore damaged at unfavorable points. In addition, it is not reliably possible to avoid gaps, through which light can enter in an undesired way, being formed between the circuit board and the housing.

Implementations of the systems and methods discussed herein are therefore based on the object of specifying a housing for a sensor which accommodates a circuit board as far as possible in the correct position and protects the latter as reliably as possible against undesired movements relative to the housing.

According to the some implementations, it has firstly been recognized that the housing parts made of plastic can have burrs and tolerances if these are milled from a plastic blank. It has further been recognized that this problem occurs in particular in the case of very small housing parts with dimensions below one centimeter. This is because it has been recognized that the circuit board must be clamped quite specifically at non-critical points, in order firstly to fix this securely and reliably and secondly not to damage it.

Finally, it has been recognized that in particular two housing parts must be connected to each other such that these cooperate to fix the circuit board reliably. It must be ensured that the circuit board is oriented in the correct position within the housing and is also fixed reliably, even if the interior of the housing can no longer be viewed for checking. Furthermore, an undesired formation of gaps between circuit board and housing must be avoided.

According to the some implementations, one housing part is designed in such a way that it deforms the means of the other housing part as the housing parts are joined together. In practical terms, a housing upper part and a housing lower part are joined together with the deformation of means, so that the housing parts form a receiving space when joined together.

In this receiving space, a circuit board is clamped and clasped by the deformed means which, when the housing parts are joined together, are bent into the receiving space. The circuit board is fixed in the correct position by the defined clamping and clasping and is no longer movable once the two housing parts have been joined together. Thus, in particular, the undesired formation of gaps is effectively avoided.

The housing is constructed simply, can be mounted simply, has only two components and reliably ensures fixing of a circuit board, so that no air gap is produced through which ambient light or light from LEDs reaches a photodiode.

Particularly preferably, the housing parts are made of a thermoplastic and produced by injection molding. It is thus possible to dispense with complicated milling processes.

The deformable means could comprise at least two side webs, the free ends of which are bent toward each other. In this way, a circuit board can be overlapped at its edges and pressed against an abutment. The circuit board is then clamped in between the abutment and the side webs and, so to speak, clasped.

The side webs or the free ends thereof could rest under pressure on their associated chamfers. By means of chamfers, the side webs can be bent into their final position gently and continuously counter to a material-dependent restoring force as the housing parts are joined together.

The side webs are preferably made of a plastic which is deformable and elastic to a certain extent. PA6 or PA66 is preferably used as the plastic. The aforementioned plastics are preferably used to produce both the housing upper part and the housing lower part by injection molding.

The side webs could be assigned to the housing lower part or integrally molded on the latter and project with their free ends in the direction of the housing upper part, wherein the side webs rest under pressure with their free ends laterally on the outside of the chamfers in the interior of the housing upper part and, as a result, are bent into the receiving space while deforming. The fact that the chamfers are associated with the one housing part and the side webs with the other housing part enables the mechanical pressure which is exerted on the two housing parts as they are joined together to be diverted and used to deform the side webs.

The side webs could project from a support base for the circuit board and thus form a receiving trough for the circuit board. In this way, the circuit board is secured against lateral displacement, since it rests laterally on the side webs. The side webs act like side walls. The circuit board is secured against displacement vertically, i.e. upward or downward, since it rests on the bent-over side webs at the top and on the support base at the bottom, which acts as an abutment.

A plurality of apertures, preferably three apertures, could be formed in the support base of the receiving trough, being separated from one another by at least one dividing wall, preferably two dividing walls. Thus, LEDs or photodiodes which are arranged on the circuit board and project from the latter can be inserted carefully into the apertures, the circuit board base board resting on the base under pressure, since the circuit board base board is clasped by the deformed side webs.

Alternatively or additionally, a further receiving trough for an optical filter could adjoin the support base, wherein the further receiving trough is opposite that receiving trough for the circuit board. An optical filter can be inserted into this further receiving trough, which lets excitation light from the LEDs through in the emission direction but is largely non-transparent to excitation light scattered back toward the photodiode. Of course, however, the optical filter lets through fluorescent light which has been reflected back by a human or animal body, in order that the photodiode can detect it.

At least one latching lug, which engages in a recess in the housing upper part and/or on the housing lower part, could be formed on the housing lower part and/or on the housing upper part, so that the housing upper part and the housing lower part are connected to each other. In this way, the housing parts can be connected reversibly to each other by a stable form fit. The form fit holds the housing parts counter to the restoring force of the deformed means. Preferably, two latching lugs are located diametrically opposite each other on the housing and are arranged on the housing lower part.

It is also conceivable that the housing parts are welded or adhesively bonded to each other. The welding can preferably be carried out by laser welding or ultrasonic welding.

A sensor could comprise a housing of the type described here and a circuit board, the edge regions of which are clasped by the means, so that the circuit board is pressed against a support base in the housing and is clamped immovably in the receiving space. This prevents gaps, through which undesired light, in particular ambient light or light from LEDs, can pass, from being formed between the circuit board and a housing part.

Against this background, the circuit board carries at least one LED for emitting excitation light and at least one photodiode for detecting fluorescent light, wherein the LED projects into a first aperture in the support base, wherein the photodiode projects into a second aperture in the support base, and wherein the two apertures are separated from each other by a non-transparent dividing wall. The LED emits excitation light in the emission direction in the direction of a human or animal body, in order to excite a marker there to fluoresce. The excitation light from the LED should, however, be kept away as well as possible from the photodiode, since the latter is intended to detect only fluorescent light. Therefore, the dividing wall is non-transparent for the light wavelengths used, both of the LED and of the fluorescent light. The dividing wall, like the entire housing lower part, is preferably made of the aforementioned plastics PA6 or PA66.

The dividing wall could rest with its upper end on the circuit board. This prevents gaps, through which undesired light can pass, from forming between a circuit board base board and the dividing walls. The upper end of the dividing wall is therefore aligned with the support base or is part of the same.

Alternatively or additionally, the dividing wall could rest with its lower end on an optical filter. The optical filter rests on the dividing wall, likewise without forming a gap, and can let through excitation light from the LEDs in the emission direction but be largely non-transparent for excitation light falling back onto the photodiode. However, the optical filter of course lets through fluorescent light through which is reflected back from a human or animal body, in order that the photodiode can detect this light.

A microprocessor or microcontroller, which can evaluate the data detected by the photodiode, is preferably also provided on the circuit board. The microprocessor can be read by a plug being inserted into a plug connection in the sensor.

The plug connection can also be used to connect a battery to the circuit board, which supplies the LEDs and the electronics with power during the measurement.

The sensor is preferably used as an organ function sensor, in particular as a kidney function sensor.

In the drawings:

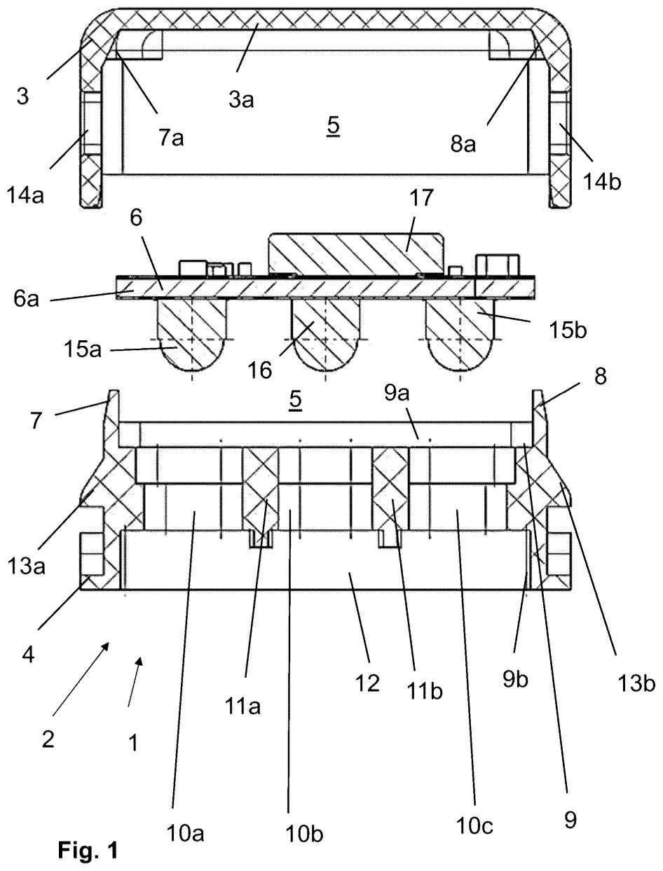

FIG. 1 shows, from bottom to top, a schematic sectional view of the housing lower part, the circuit board and the housing upper part in an exploded illustration,

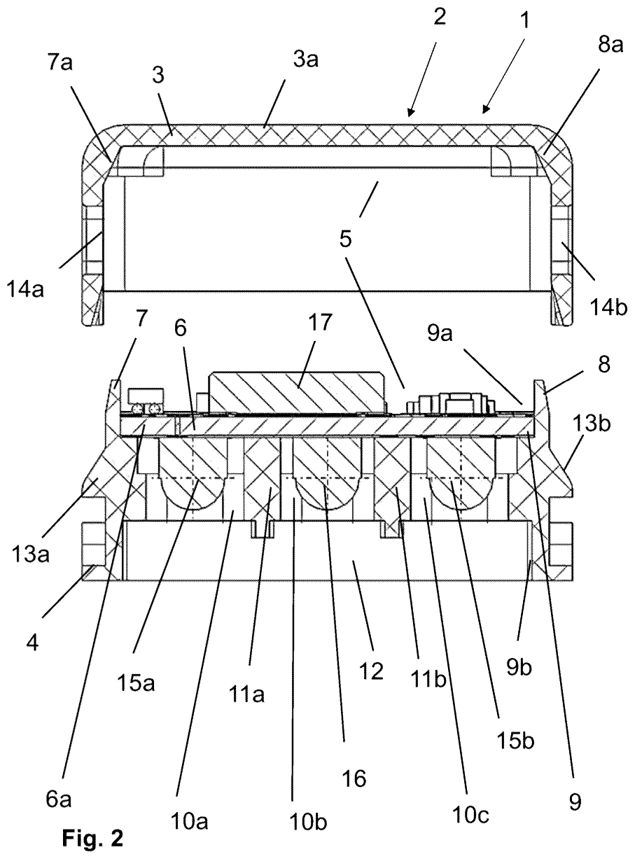

FIG. 2 shows, at the bottom, an arrangement comprising the housing lower part into which the circuit board is inserted, specifically laid between two side webs, and, at the top, the housing upper part, which has a closed cover,

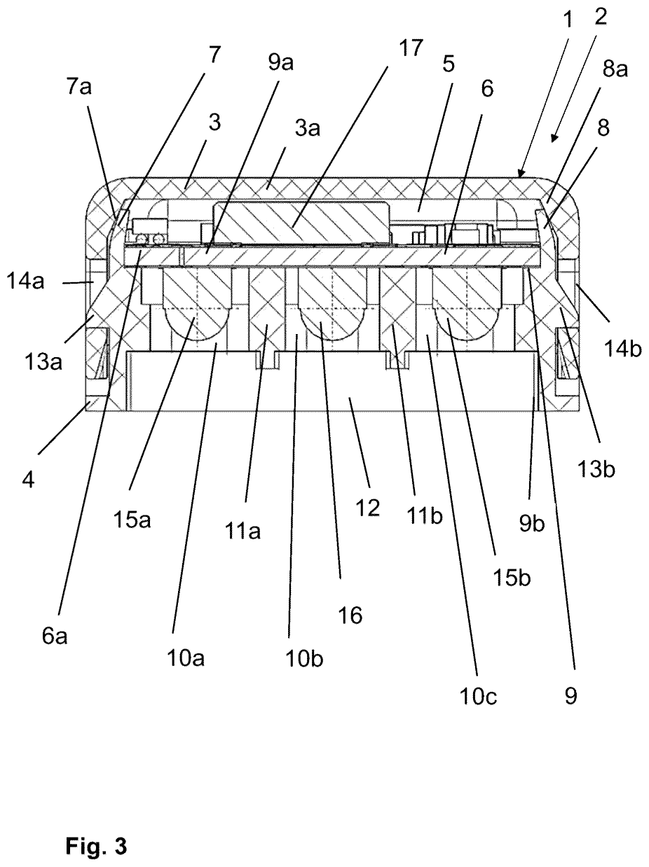

FIG. 3 shows the housing in the assembled state, which accommodates the circuit board in its interior and thus forms a sensor, wherein side webs of the housing lower part are bent inward and deformed in order to clasp the circuit board slightly in its edge regions and/or to clamp the circuit board in its edge regions, whereby the circuit board is pressed against the housing lower part, and

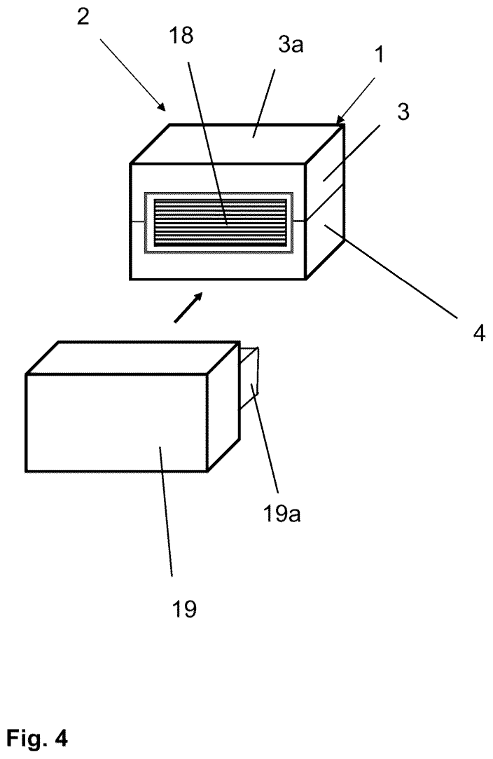

FIG. 4 shows a schematic illustration of an arrangement which comprises the housing and a battery, wherein the housing and the battery are illustrated in a state separated from each other.

In the drawings, the following elements are represented by numerals:
1 Housing
2 Sensor
3 Housing upper part of 1
3a Cover of 3
4 Housing lower part of 1
5 Receiving space in 1
6 Circuit board
6a Circuit board base board
7 First side web of 4
7a First chamfer in 3
8 Second side web of 4
8a Second chamfer in 3
Support base
9a Receiving trough in 4 for 6
9b Further receiving trough in 4 for 12
10a First aperture in 9a
10b Second aperture in 9a
100 Third aperture in 9a
11a First dividing wall
11b Second dividing wall
12 Optical filter
13a First latching lug on 4
13b Second latching lug on 4
14a First recess in 3
14b Second recess in 3
15a First LED
15b Second LED
16 Photodiode
17 Microprocessor or microcontroller
18 Plug connection
19 Battery
19a Plug of 19

FIG. 1 shows, in an exploded illustration, a housing 1 for a sensor 2, comprising a housing upper part 3 and a housing lower part 4 which, in the assembled state, form a receiving space 5 which is suitable to receive a circuit board 6. The housing lower part 4 is assigned deformable means which, in the assembled state of the housing parts 3, 4, are bent into the receiving space 5.

FIG. 3 shows the assembled state of the housing 1, in which the means are bent into the receiving space 5. The deformable means comprise at least two side webs 7, 8, the free ends of which are bent toward each other. The bent free ends clasp the circuit board 6.

The side webs 7, 8, specifically in practical terms the free ends thereof, rest under pressure on chamfers 7a, 8a respectively assigned thereto. In practical terms, the side webs 7, 8 are assigned to the housing lower part 4, namely integrally molded on the latter. The chamfers 7a, 8a are formed in corner regions in the interior of the housing upper part 3. The side webs 7, 8 project with their free ends in the direction of the housing upper part 3, wherein the side webs 7, 8 rest under pressure with their free ends laterally on the outside of the chamfers 7a, 8a in the interior of the housing upper part 3. In this way, the side webs 7, 8 are bent into the receiving space 5 while deforming.

The side webs 7, 8 project from a support base 9 for the circuit board and thus form a receiving trough 9a for the circuit board 6.

Formed in the support base 9 of the receiving trough are a plurality of apertures 10a, 10b, 10c, which are separated from one another by two dividing walls 11a, 11b. The support base 9 is adjoined by a further receiving trough 9b for an optical filter 12, wherein the further receiving trough 9b is opposite to the receiving trough 9a for the circuit board 6 in the vertical direction.

Formed on the housing lower part 4 are two latching lugs 13a, 13b, which each engage in a recess 14a, 14b in the housing upper part 3, so that the housing upper part 3 and the housing lower part 4 are connected to each other.

FIG. 3 also shows in practical terms a sensor 2, comprising the housing 1 and the circuit board 6, the edge regions of which are clasped by the means, so that the circuit board 6 is pressed against the support base 9 in the housing 1 and is immovably clamped in the receiving space 5. The housing upper part 3 has a closed cover 3a, so that the electronics of this circuit board 6 are protected.

The circuit board 6 carries two LEDs 15a, 15b for emitting excitation light and at least one photodiode 16 for detecting fluorescent light, wherein the LED 15a projects into a first aperture 10a in the support base 9, wherein the photodiode 16 projects into a second aperture 10b in the support base 9, wherein the second LED 15b projects into a third aperture 10c in the support base 9, wherein the apertures 10a, 10b are separated from each other by a first non-transparent dividing wall 11a, and wherein the apertures 10b, 10c are separated laterally from each other by a second non-transparent dividing wall 11b.

The dividing walls 11a, 11b rest with their upper ends on the circuit board 6 and form part of the support base 9 or are aligned with the latter and with one another. The dividing walls 11a, 11b rest with their lower ends on an optical filter 12. Formed in the optical filter 12 are grooves, in which the dividing walls 11a, 11b engage with tapers in the manner of a tongue and groove. This also avoids undesired light being propagated laterally.

A microprocessor 17, which can evaluate the data captured by the photodiode 16, is arranged on the circuit board 6. The microprocessor 17 can be read by a plug being plugged into a plug connection 18 in the sensor 2. The plug connection 18 can also be used to connect a battery 19 to the circuit board 6, which supplies the LEDs 15a, 15b and the remaining electronics with power during the measurement. This is illustrated schematically in FIG. 4.

FIGS. 1 and 2 show that the side webs 7, 8 are not yet deformed in the non-assembled state of the housing parts 3, 4 and project rectilinearly and freely in the direction of the housing upper part 3. Formed in the housing upper part 3 are mutually opposite chamfers 7a, 8a, on which the free ends of the side webs 7, 8 are placed as the housing parts 3, 4, are pressed together and are bent inward in the direction of the receiving space 5.

After the housing parts 3, 4 have been joined together, the free ends of the side webs 7, 8 engage around the circuit board base board 6a on their opposite end regions and press the circuit board base board 6a against the support base 9 in the receiving trough 9a which is provided for the circuit board 6. This is illustrated in FIG. 3.

FIGS. 1 to 3 show and FIG. 4 schematically shows that in the assembled state the housing parts 3, 4 form an opening for a plug connection 18. The finished housing 1 has a closed cover 3a on the housing upper part 3, which protects the circuit board 6 against access, so that, for example, the microprocessor 17 cannot be grasped or loaded.

At the bottom, that is to say in the direction of the excitation light outlet, the housing 1 is open, at least for the passage of light through the apertures 10a to 10c, but is closed mechanically by the optical filter 12, so that no access from below is possible either.

A plug 19a of a battery 19 can be electrically and mechanically connected to the circuit board 6 by means of the plug connection 18 only through the opening for the plug connection 18. The plug connection 18 is used simultaneously to read data which is stored in the microprocessor 17 or a memory.

Preferably, the width and/or length of the housing 1 is/are less than 1 cm. More preferably, the height of the housing 1 is less than 1 cm.

While the foregoing written description of the methods and systems enables one of ordinary skill to make and use what is considered presently to be the best mode thereof, those of ordinary skill will understand and appreciate the existence of variations, combinations, and equivalents of the specific embodiment, method, and examples herein. The present methods and systems should therefore not be limited by the above-described embodiments, methods, and examples, but by all embodiments and methods within the scope and spirit of the disclosure.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

What is claimed is:

1. A housing for a sensor, comprising:
a housing upper part; and
a housing lower part;
wherein, in the assembled state, the housing upper part and the housing lower part form a receiving space which is suitable to receive a circuit board,
wherein the housing upper part and/or the housing lower part comprise deformable means which, in the assembled state of the housing parts, are bent into the receiving space.

2. The housing as claimed in claim 1, wherein the deformable means comprise at least two side webs, the free ends of which are bent toward one another.

3. The housing as claimed in claim 2, wherein the side webs or the free end thereof rest under pressure on corresponding chamfers on the housing upper part and/or the housing lower part.

4. The housing as claimed in claim 2, wherein the side webs are part of the housing lower part or are integrally molded on the housing lower part and project with their free ends in the direction of the housing upper part, and
wherein the side webs rest under pressure with their free ends laterally on the outside of chamfers in the interior of the housing upper part and, as a result, are bent into the receiving space while deforming.

5. The housing as claimed in claim 2, wherein the side webs project from a support base for the circuit board and thus form a receiving trough for the circuit board.

6. The housing as claimed in claim 5, wherein a plurality of apertures which are separated from one another by at least one dividing wall are formed in the support base of the receiving trough, and/or wherein a further receiving trough for an optical filter adjoins the support base, wherein the further receiving trough is opposite the receiving trough for the circuit board.

7. The housing as claimed in claim 1, further comprising at least one latching lug, configured to engage in a recess in the housing upper part and/or on the housing lower part, formed on the housing lower part and/or on the housing upper part, so that the housing upper part and the housing lower part are connected to each other.

8. A sensor, comprising:
a housing as claimed in claim 1; and
a circuit board, the edge regions of which are clasped by the deformable means, so that the circuit board is pressed against a support base in the housing and is immovably clamped in the receiving space.

9. The sensor as claimed in claim 8, wherein the circuit board carries at least one light-emitting diode (LED) for emitting excitation light and at least one photodiode for detecting fluorescent light, wherein the LED projects into a first aperture in the support base, wherein the photodiode projects into a second aperture in the support base, and wherein the two apertures are separated from each other by a non-transparent dividing wall.

10. The sensor as claimed in claim 9, wherein the dividing wall rests with its upper end on the circuit board and/or wherein the dividing wall rests with its lower end on an optical filter.
